(19) United States
(12) Patent Application Publication
(10) Pub. No.: US 2012/0091246 A1
(43) Pub. Date: Apr. 19, 2012

(54) CORD WINDER SEAT STRUCTURE

(76) Inventor: Tser Wen CHOU, Taipei City (TW)

(21) Appl. No.: 12/906,294

(22) Filed: Oct. 18, 2010

(51) Int. Cl. E06B 9/38

(52) U.S. Cl. 242/364

(57) ABSTRACT

A cord winder seat structure installed in a shutter rail for controlling opening/closing of the slats of the shutter. The cord winder seat structure includes a cord reel having a polygonal drum body. The polygonal drum body is composed of several plane sidewalls connected with each other. The polygonal drum body has several angles contained between the plane sidewalls. A pull cord is wound around the polygonal drum body for rotating the cord reel. The angles of the polygonal drum body serve as pull points for the pull cord. When a user pulls the pull cord to rotate the cord reel, the pull cord can apply a pull force to the angles to more precisely operate and locate the cord reel and save strength. An oblique slot is formed on a plane sidewall of the drum body on an inner side thereof to avoid tangling of the pull cord.

### BACKGROUND OF THE INVENTION

1. Field of the Invention

The present invention relates generally to a cord winder seat structure installed in a shutter rail, and more particularly to a cord winder seat structure including a cord reel having a polygonal drum body. The polygonal drum body is composed of several plane sidewalls containing several angles. A pull cord is wound around the polygonal drum body for rotating the cord reel. The angles of the polygonal drum body serve to securely apply a winding force to the pull cord, whereby the cord reel can be more precisely operated to save strength without slippage. Accordingly, the opening/closing of the slats of the shutter can be more easily controlled by means of pulling the pull cord.

2. Description of the Related Art

A cord winder seat is generally used to control opening/closing of the slats of a shutter and adjust the angle of the slats for shading sunlight. For example, U.S. Pat. Nos. 6,561,254, 5,636,677 and 5,680,892 disclose some typical cord winder seat structures. Such cordwinder seat structure includes a cord reel formed with a through hole on one face. A pull cord can be passed through the through hole and fixed with the cord reel. By means of pulling the pull cord, the cord reel is rotated. At this time, a shaft inserted in the cord reel is synchronously rotated with the cord reel to convert the slats between vertical state and horizontal state. The cord reel has a cylindrical drum body with a smooth face. Therefore, it is hard for the drum body to apply a winding force to the pull cord for winding the pull cord around the drum body. When pulling the pull cord, the pull cord has no pull point and tends to slip. In this case, it is hard for the pull cord to control the rotation of the cord reel and locate the slats of the shutter. As a result, it is more laborious for a user to pull the pull cord and it is difficult to precisely control the rotation of the cord reel. This will affect the sun shading effect of the shutter.

### SUMMARY OF THE INVENTION

It is therefore a primary object of the present invention to provide a cord winder seat structure installed in a shutter rail for enhancing the sun shading effect of the slats of a shutter. The present invention is an improvement of this applicant's U.S. Pat. No. 6,761,204. The cord winder seat structure includes a cord reel having a polygonal drum body. The polygonal drum body of the cord reel is composed of several plane sidewalls connected with each other. The polygonal drum body has several angles contained between the plane sidewalls. A pull cord is wound around the polygonal drum body for rotating the cord reel. The polygonal drum body is composed of several plane sidewalls connected with each other. The polygonal drum body has several angles contained between the plane sidewalls. A pull cord is wound around the polygonal drum body for rotating the cord reel. The angles of the polygonal drum body serve as pull points for the pull cord. When a user pulls the pull cord to rotate the cord reel, the pull cord can apply a pull force to the angles to more precisely operate and locate the cord reel and save strength. This overcomes the problem of slippage of the pull cord that exists in the cylindrical drum body of the conventional cord reel. Moreover, by means of the polygonal drum body of the cord reel, the slats of the shutter can be securely located in vertical positions to enhance sun shading effect of the shutter.

To achieve the above and other objects, the cord winder seat structure of the present invention includes: a cord winder seat including a left casing and a right casing, the left casing being coupled with the right casing by means of a tongue section and a socket to form the cord winder seat; a shaft positioned in the cord winder seat and having multiple teeth annularly arranged on an outer circumference of the shaft; and a cord reel including a polygonal drum body, a first disc section, a second disc section and a worm section, the first and second disc sections having larger area and being positioned on two sides of the drum body, the worm section extending from the second disc section into the cord winder seat, the worm section being drivingly engaged with the teeth of the shaft, an oblique slot being formed on a plane sidewall of the drum body, whereby a cord head of a pull cord can be passed through the slot and fixed with the drum body. The polygonal drum body is composed of several plane sidewalls connected with each other. The polygonal drum body has several angles contained between the plane sidewalls. The pull cord is wound around the polygonal drum body for rotating the cord reel. The angles of the polygonal drum body serve as pull points for the pull cord. When a user pulls the pull cord to rotate the cord reel, the pull cord can apply a pull force to the angles to more easily operate the cord reel and save strength. Moreover, by means of the angles of the polygonal drum body, the shaft can more precisely control and locate the slats of the shutter.

The present invention can be best understood through the following description and accompanying drawings, wherein:

### BRIEF DESCRIPTION OF THE DRAWINGS

FIG. 1 is a perspective exploded view of a first embodiment of the present invention;

FIG. 2 is a perspective view of the cord reel of the first embodiment of the present invention;

FIG. 3 is a perspective assembled view of the first embodiment of the present invention;

FIG. 4 is a sectional assembled view of the first embodiment of the present invention;

FIG. 5 is a sectional view according to FIG. 4, showing the installation of the pull cord on the cord reel of the present invention;

FIG. 6 is a sectional view according to FIG. 4, showing that the present invention is mounted in a shutter rail;

FIG. 7 shows the use of the present invention;

FIG. 8 shows that the pull cord is pulled downward;

FIG. 9 shows a second embodiment of the present invention; and

FIG. 10 shows a third embodiment of the present invention.

### DETAILED DESCRIPTION OF THE PREFERRED EMBODIMENTS

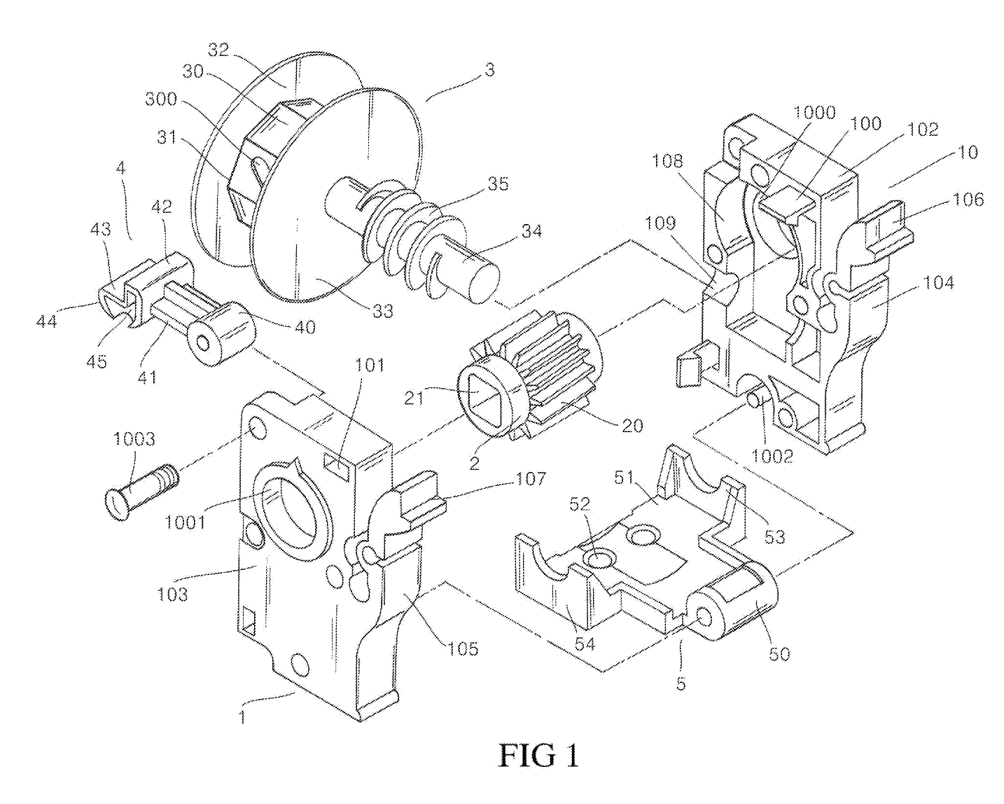

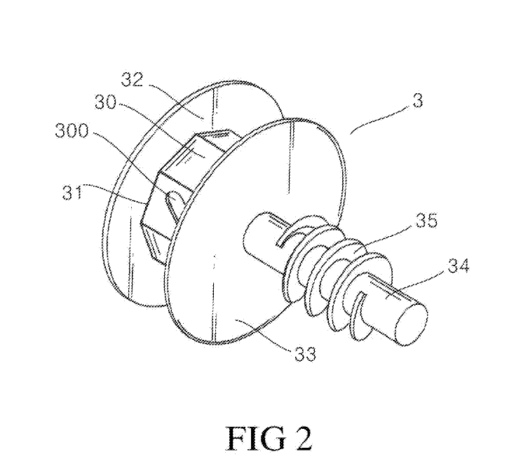

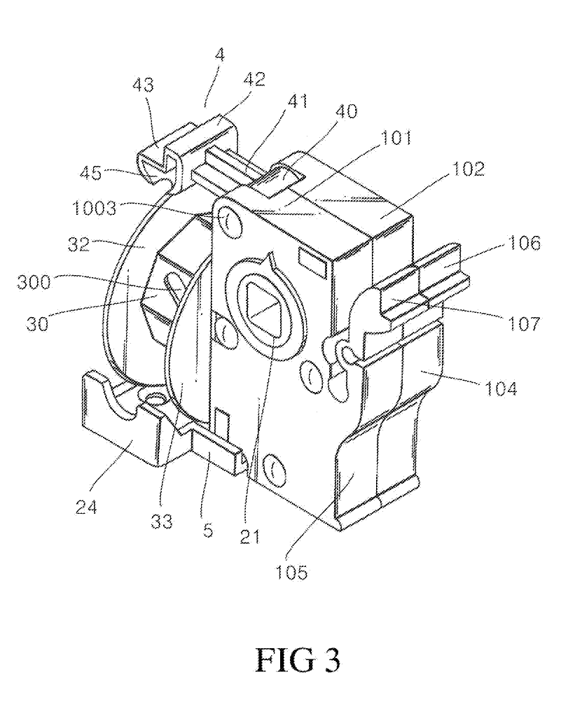

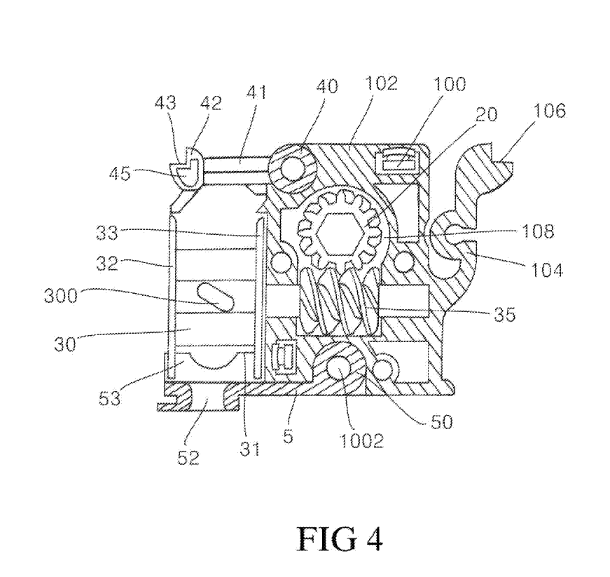

Please refer to FIGS. 1 to 4. According to a first embodiment, the cord winder seat structure of the present invention mainly includes a left casing 1 and a right casing 10. The left casing 1 is coupled with the right casing 10 by means of a tongue section 100 and a socket 101 to form a hollow cord winder seat. The cord winder seat structure of the present invention further includes a shaft 2 enclosed in the hollow cord winder seat and a cord reel 3 drivingly engaged with the shaft 2. The cord reel 3 protrudes from the cord winder seat to an outer side thereof. The cord winder seat structure of the present invention further includes a movable cover board 4 upward pivotably connected with an upper end of the cord winder seat and a movable bracket 5 downward pivotably connected with a lower end of the cord winder seat.

The left casing 1 and the right casing 10 correspond to each other in configuration. The left casing 1 and the right casing 10 respectively have two casing bodies 102, 103 each having a resilient arm 104, 105 extending from one side thereof. Each resilient arm 104, 105 has a top end formed with a chuck section 106, 107 for fixedly chucking a shutter rail. Each casing body 102, 103 has an inner face formed with a cavity 108 and a recess 109 in communication with the cavity 108. (The cavity and the recess of the left casing 1 are not shown.) The shaft 2 is restrictedly received in the cavities 108, while a worm section 35 of the cord reel 3 is restrictedly received in the recesses 109. A bottom wall of each cavity 108 is formed with a through hole 1000 (1001). The shaft 2 is rotatably received in the through holes 1000 (1001) and drivingly engaged with the worm section 35 of the cord reel 3.

The shaft 2 includes multiple teeth 20 annularly arranged on an outer circumference of the shaft 2 for engaging with the worm section 35 of the cord reel 3. The shaft 2 is further formed with a passage 21 for a rectangular control bar (not shown) to pass therethrough. The rectangular control bar extends out of the through holes 1000 (1001) and is drivable and rotatable by the shaft 2. The cord reel 3 is positioned on one side of the cord winder seat. The cord reel 3 includes a polygonal drum body 31, a first disc section 32 and a second disc section 33. The first and second disc sections 32, 33 have larger area and are positioned on two sides of the polygonal drum body 31. The polygonal drum body 31 is composed of several plane sidewalls 30 connected with each other. The worm section 34 of the cord reel 3 extends from the second disc section 33 into the cord winder seat. The polygonal drum body 31 has several angles 300 contained between the plane sidewalls 30. An oblique slot 301 is formed on a specific plane sidewall 30 of the polygonal drum body 31. A head section of a pull cord is passed through the slot 301 and knotted to be fixed with the polygonal drum body 31. The pull cord is wound around the polygonal drum body 31, whereby the cord reel 3 can be rotated by means of pulling the pull cord. The worm section 34 of the cord reel 3 has a thread 35 for engaging with the shaft 2. Accordingly, the shaft 2 and the cord reel 3 are rotatably installed in the cavities 105 and the recesses 108, 109 and drivingly engaged with each other.

The movable cover board 4 includes a sleeve body 40 and a retainer body 42 connected to the sleeve body 40 via a connection arm 41. The retainer body 42 has a holding section 43 for supporting and holding the shutter rail. The retainer body 42 further has an arcuate face 44 for the retainer body 42 to be easily pressed down along an arcuate face of the shutter rail. Two sides of the retainer body 42 are further formed with dents 45 for reinforcing the retainer body 42. The movable cover board 4 is upward pivotably connected with the upper end of the cord winder seat by means of a threaded rod 1003 passing through the sleeve body 40.

The movable bracket 5 includes a sleeve body 50 and a chassis 51 extending from the sleeve body 50. The chassis 51 is positioned under the cord reel 3 corresponding to the polygonal drum body 31 thereof. The chassis 51 is formed with two perforations 52 for the pull cord 6, which is wound around the cord reel 3, to pass through. The chassis 51 has two protective walls 53, 54 uprightly formed on two sides of the chassis 51 for shielding two sides of the cord reel 3. The left and right casings 1, 10 respectively have two projecting locating rods 1002. The locating rods 1002 can be inserted into the sleeve body 50 of the movable bracket 5, whereby the movable bracket 5 is downward pivotably assembled with the left and right casings 1, 10.

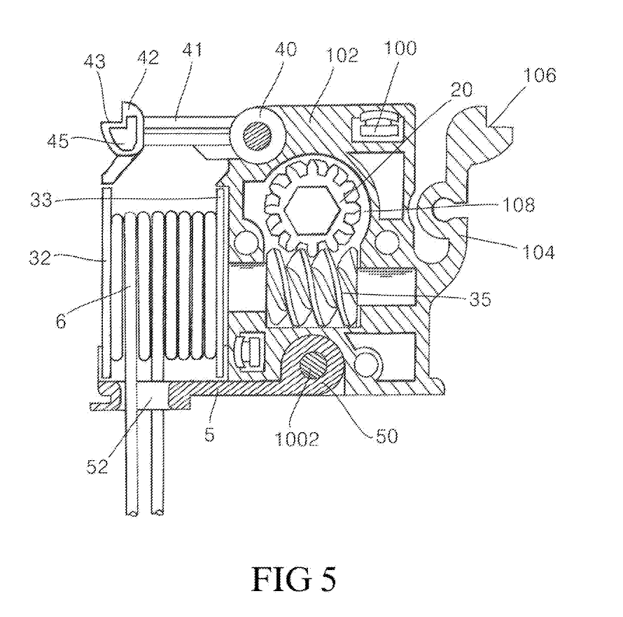

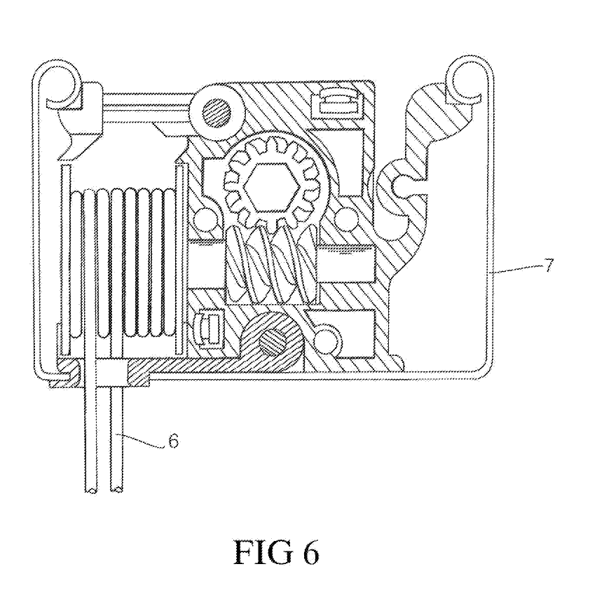

When installed (as shown in FIG. 5), the movable cover board 4 is turned upward to provide a cord winding space above the polygonal drum body 31. The movable bracket 5 is turned downward to provide a cord winding space below the polygonal drum body 31. The pull cord 6 is wound around the polygonal drum body 31 of the cord reel. The suspending segments of the pull cord 6 are passed through the perforations 52 of the movable bracket 5 for a user's hand to hold and control the rotation of the cord reel 3. By means of the chuck sections 106, 107 of the resilient arms 104, 105, the movable cover board 4 and the movable bracket 5, the cord winder seat is completely retained on the shutter rail 7 (as shown in FIG. 6).

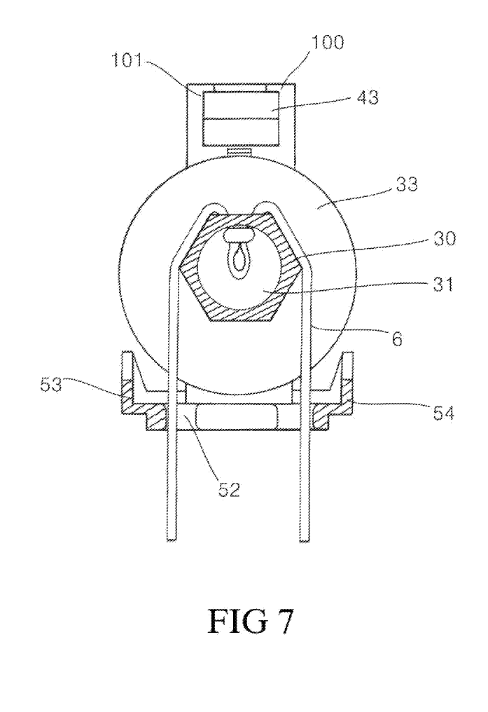

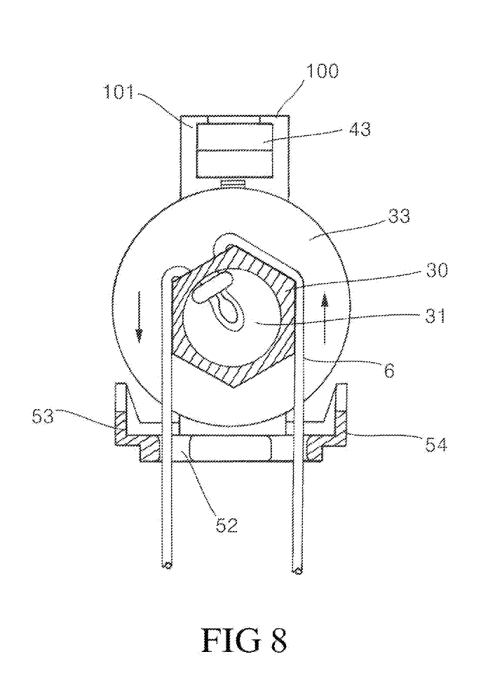

Referring to FIGS. 7 and 8, the pull cord 6 can apply a pull force to the angles 300 of the cord reel 3, which serve as pull points.

Accordingly, when a user pulls the pull cord 6 to rotate the cord reel 3, the pull cord 6 can apply a pull force to the angles 300 to easily rotate the cord reel 3. Accordingly, the cord reel 3 can be more precisely operated to save strength without slippage.

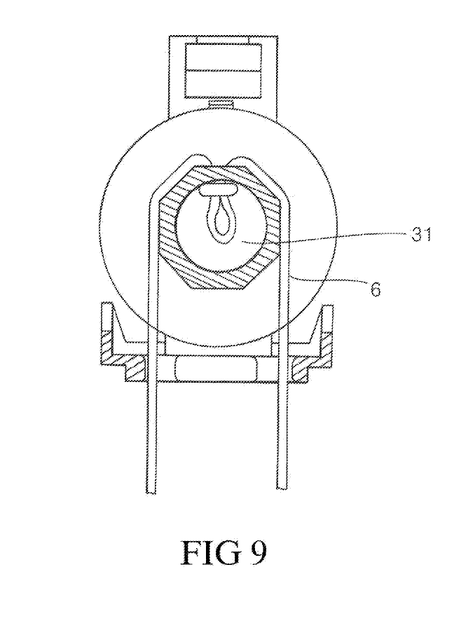

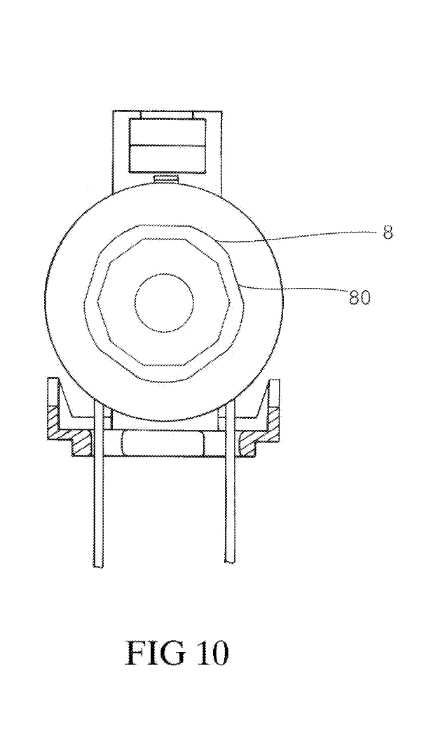

FIGS. 9 and 10 show a second embodiment and a third embodiment of the present invention. In the second embodiment of FIG. 9, the drum body of the reel cord 3 has eight plane sidewalls containing eight angles. In the third embodiment of FIG. 10, the drum body of the reel cord 3 has five arcuate sidewalls 8 and five plane sidewalls 80.

The above embodiments are only used to illustrate the present invention, not intended to limit the scope thereof. Many modifications of the above embodiments can be made without departing from the spirit of the present invention.

What is claimed is:

1. A cord winder seat structure comprising:
a cordwinder seat including a left casing and a right casing, the left casing being coupled with the right casing by means of a tongue section and a socket to form the cord winder seat, the left casing and the right casing respectively having two casing bodies each having a resilient arm extending from an outer side of the casing body, each resilient arm having a chuck section, each casing body having an inner face formed with a cavity and a recess, a bottom wall of each cavity being formed with a through hole;
a shaft formed with a passage and having multiple teeth annularly arranged on an outer circumference of the shaft, the shaft being restrictedly rotatably received in the cavities of the casing bodies;
a cord reel including a drum body, a first disc section, a second disc section and a worm section, the first and second disc sections having larger area and being positioned on two sides of the drum body, the worm section extending from the second disc section into the cord winder seat, the worm section being restrictedly rotatably received in the recesses of the casing bodies and drivingly engaged with the teeth of the shaft, an oblique slot being formed on a plane sidewall of the drum body, whereby a pull cord can be passed through the slot and knotted to be fixed with the drum body;
a movable cover board including a sleeve body and a retainer body connected to the sleeve body via a connection arm, the movable cover board being upward pivotably connected with an upper end of the cord winder seat; and
a movable bracket including a sleeve body and a chassis extending from the sleeve body, the movable bracket being downward pivotably connected with a lower end of the cord winder seat;
said cord winder seat structure being characterized in that the drum body of the cord reel is a polygonal drum body composed of several plane sidewalls connected with each other, the polygonal drum body having several angles contained between the plane sidewalls as pull points for the pull cord, whereby when a user pulls the pull cord to rotate the cord reel, the pull cord can apply a pull force to the angles to more precisely operate and locate the cord reel and save strength.

2. The cord winder seat structure as claimed in claim 1, wherein the number of the plane sidewalls is larger than four.

3. The cord winder seat structure as claimed in claim 1, wherein the oblique slot is formed on the plane sidewall of the drum body in adjacency to an inner side thereof.

4. The cord winder seat structure as claimed in claim 1, wherein the plane sidewalls of the drum body have unequal widths.

5. The cord winder seat structure as claimed in claim 1, wherein the angles contained between the plane sidewalls of the drum body range from 90 degrees to 150 degrees.

6. The cord winder seat structure as claimed in claim 1, wherein two sides of the movable cover board are formed with reinforcing dents.

7. The cord winder seat structure as claimed in claim 1, wherein the drum body of the cord reel is a decagonal drum body, a hexagonal drum body or an octagonal drum body.
